(19) United States
(12) Patent Application Publication
(10) Pub. No.: US 2010/0002743 A1
(43) Pub. Date: Jan. 7, 2010

(54) LASER FOCUSING THROUGH TURBULENT MEDIUM

(76) Inventors: Vladimir B. Markov, Irvine, CA (US); Anatoliy I. Khizhnyak, Irvine, CA (US)

Correspondence Address: Haynes and Boone, LLP;IP Section, 2323 Victory Avenue, SUITE 700, Dallas, TX, 75219, US

(21) Appl. No.: 12/172,032

(22) Filed: Jul. 11, 2008

Related U.S. Application Data
(60) Provisional application No. 60/949,688, filed on Jul. 13, 2007.

(51) Int. Cl. H01S 3/086; G02B 26/06

(52) U.S. Cl. 372/96; 359/291

(57) ABSTRACT

Methods and systems for performing target-in-the-loop, real-time laser beam phase aberration compensation through a turbulent atmosphere are disclosed. The methods and systems can distinguish between phase aberration contributions from atmospheric turbulence-induced phase aberration and target-induced phase aberration caused by target surface roughness. Selected components of incoming light can be used to define a reversed wavefront and a reverse direction of propagation such that a laser beam returned to a target tends to be concentrated upon a desired region of a target. In this manner, applications such as laser target designation, tracking, pointing, active imaging, and directed energy systems are better facilitated.

### PRIORITY CLAIM

This patent application claims the benefit of the priority date of U.S. provisional patent application Ser. No. 60/949,688, filed on Jul. 13, 2007 and entitled Method of the Laser Beam Focusing on the Extended Target Through Turbulent Atmosphere (docket no. M-17018-V1 US) pursuant to 35 USC 119. The entire contents of this provisional patent application are hereby expressly incorporated by reference.

### GOVERNMENT RIGHTS

This invention was made with Government support under Contract No. FA9453-05-C-0031 awarded by the U.S. Air Force. The Government has certain rights in the invention.

### TECHNICAL FIELD

The present invention relates generally to optics. The present invention relates more particularly to methods and systems for controlling a laser beam, including for focusing and directing the laser beam onto an extended target through a turbulent medium such as the atmosphere.

### BACKGROUND

Laser beam propagation though a turbulent medium is common. For example, such applications include laser target designation, tracking, pointing, active imaging, and directed energy systems. Such applications can provide a substantial advantage in battlefield situations. The use of laser beams with controlled parameters is of interest for industrial (welding, cutting, marking), medical (surgery, eye surgery, skin removal, tattoos cleaning), free-space telecommunication, and other purposes.

However, the use of laser beams that propagate in a turbulent medium and in the atmosphere, in particular, often requires a real-time solution to the problem of laser beam aberration caused by the turbulence. As is well known, a turbulent medium degrades the angular-spatial characteristics of lasers beams. For example, atmospheric turbulence causes such unwanted side effects as laser beam wondering, jitter and limits the ability to focus it at desired area upon a target.

Adaptive optics has been used in an attempt to mitigate such problems caused by atmospheric turbulence. However, it has been demonstrated that contemporary adaptive optics based methodologies suffer from substantial deficiencies. This is particularly true when considering target-in-the-loop (TIL) compensation methodologies, especially when dealing with extended (resolved) targets with rough surfaces. Problems occur in such instances because these contemporary methodologies do not distinguish between the contributions from atmospheric turbulence induced phase aberrations and target induced effects caused by target surface roughness.

As such, although the prior art has recognized, to a limited extent, the problems caused by atmospheric turbulence, the proposed solutions have, to date, been ineffective in providing a satisfactory remedy. Therefore, it is desirable to provide better methods and systems for compensating for atmospheric turbulence.

### BRIEF SUMMARY

Methods and systems for performing target-in-the-loop (TIL), real-time laser beam phase aberration compensation and for directing a laser beam through a turbulent medium are disclosed. Examples of embodiments can operate in presence of both phase aberration contributions from the turbulent medium and target-induced phase aberration contributions caused by target surface roughness.

According to an example of an embodiment, a method for enhancing laser beam focusing upon a target can comprise using a selector to select a portion of an image of a target formed by a first laser beam. The selected portion of the laser beam can be used for phase conjugation so as to facilitate the definition of a pre-distorted second laser beam.

According to an example of an embodiment, a method for controlling the location of a focused laser beam upon a target can comprise using a selector to define a preferred position of a laser illumination spot on a target. The selected portion of the laser beam can be used for phase conjugation so as to deliver the laser beam at the desired illumination spot on a target.

According to an example of an embodiment, a method for enhancing laser beam focusing upon a target can comprise reflecting only selected components of incoming light. This facilitates the definition of a reversed wavefront and a reverse direction of propagation, such that a laser beam returned to a target tends to be concentrated upon a desired region of a target.

According to an example of an embodiment, a method for performing TIL, real-time laser beam phase aberration compensation through a turbulent atmosphere can comprise distinguishing between contributions from atmospheric turbulence-induced phase aberration and target-induced phase aberration, such as that caused by target surface roughness.

According to an example of an embodiment, a method for enhancing laser beam focusing upon a target can comprise directing a first laser beam through a turbulent atmosphere toward a target so as to illuminate a comparatively large area upon the target, receiving light from the first laser beam that was scattered from the target, and focusing the light in an image plane so as to form a blurred image.

A spot on the blurred image in the image plane of an optical system can be selected. The spot can correspond to a comparatively small area upon the target. Selected light can be directed to an optical phase conjugate mirror. A second laser beam can be directed from the optical phase conjugate mirror to the target. The second laser beam can at least partially define a pre-distorted laser beam which, when acted upon by the atmosphere, defines a spot having enhanced focus upon the target.

According to an example of an embodiment, a method for enhancing laser beam focus upon a target can comprise forming a laser cavity using an optical phase conjugate mirror performing as one reflector and using the target as another reflector. Light reflected from a selected region of the target can be selectively allowed to resonate within the laser cavity.

According to an example of an embodiment, a system for performing real-time laser beam aberration compensation through a turbulent atmosphere can comprise a laser source, optics for focusing light from the laser source upon a target and for forming an image of light scattered from the target, a selector for selecting a specific spot in an image plane, and an optical phase conjugate mirror receiving light from the selected spot in the image plane for pre-distorting light transmitted to the target.

According to an example of an embodiment, a method for directing a laser beam at a selected location on a target can comprise illuminating a target with a laser beam, forming an image of the target with light scattered by the target, selecting a location on the image, performing phase conjugation on light from the selected location, and directing phase conjugated light to the target.

Benefits include facilitating applications such as laser target designation, tracking, pointing, active imaging, and directing energy. Those skilled in the art will appreciate that various other applications are similarly enhanced.

This invention will be more fully understood in conjunction with the following detailed description taken together with the following drawings.

### BRIEF DESCRIPTION OF THE DRAWINGS

FIG. 1 is a semi-schematic block diagram showing an enhanced laser beam target focusing system, according to an example of an embodiment;

FIG. 2 is a semi-schematic block diagram showing an extended length laser cavity having an optical phase conjugate mirror (OPCM), according to an example of an embodiment; and

FIG. 3 is a semi-schematic block diagram showing two conjugated hot spots (one on the target and the other in the telescope image plane), according to an example of an embodiment.

Embodiments of the present invention and their advantages are best understood by referring to the detailed description that follows. It should be appreciated that like reference numerals are used to identify like elements illustrated in one or more of the figures.

### DETAILED DESCRIPTION

Methods and systems for enhancing the focus of a laser spot at a preferred location on a target are disclosed. More particularly, examples of embodiments facilitate the focusing and positioning a resulting hot-spot of a laser beam upon an extended target through a turbulent atmosphere.

The use of lasers for applications such as laser target designation, tracking, pointing, active imaging, and directed energy systems requires real-time compensation of laser beam aberrations due to turbulence in the atmosphere. As discussed above, contemporary compensation methodologies suffer from serious deficiencies when using TIL compensation, particularly when dealing with extended (resolved) targets that have rough surfaces. This is primarily because this contemporary approach doesn't provide compensation of phase aberrations resulting from atmospheric turbulence induced phase aberrations and target induced effects that are caused by target surface roughness.

Contemporary optical systems use double-pass propagation methodologies. The target-in-loop propagation geometry with an extended non-cooperative target represents a challenge for adaptive optics applications. This approach attempts to maximize the laser power/energy density (hot-spot brightness) on the target in the presence of dynamically changing inhomogeneities along the propagation path. In atmospheric TIL systems, the refractive-index inhomogeneities can be associated with turbulence, aero-optics effects, and/or the nonlinear refraction effects caused by a high-energy laser beam propagating through the atmosphere. The term “turbulence” can be used herein to refer to any such inhomogeneities.

According to contemporary practice, one of the primary obstacles to delivering high laser power/energy density on a non-cooperative target is the lack of an accurate method for detecting and characterizing the target-scattered laser beam. The target-scattered laser beam contains information that can be used in focusing the laser beam upon the target. One or more embodiments use this information to facilitate enhanced focusing of the laser beam.

The wavefront of a laser beam transmitted through a turbulent atmosphere is spatially modulated due to the effects of random phase beam modulation along the path to the target. Such modulation results in an incremental broadening of the angular spectrum of the beam. Due to the completely random character of this phase modulation, the intensity distribution of a laser beam changes from the original Gaussian profile to a spatially non-uniform beam comprising of multiple speckles. An extra broadening of this angular spectrum is added by laser beam scattering off of a rough target. The structure of the returning beam is affected again by the atmosphere turbulence on its path from the target to the receiving optics, resulting in substantial image blurring.

One or more embodiments facilitate the detection and characterization of target-scattered laser beams. This detection and characterization can facilitate pre-distortion of the outgoing laser beam so as to compensate for atmospheric turbulence effects. Such pre-distortion of the laser beam can facilitate enhanced focusing thereof upon the target.

One or more embodiments comprise methods and system for effectively compensating for laser beam aberrations in TIL systems. A proposed solution can be based on a recent analysis of hot-spot formation on a resolved target when an optical phase conjugate mirror (OPCM) is placed at the transmitting end of the TIL system. The role of the optical phase conjugate mirror according to such embodiments can be to pre-distort the outgoing laser beam to allow for compensation of the atmospheric perturbations, as well as effects associated with the light scattering from the target surface.

According to an example of an embodiment, a method for enhancing laser beam focusing upon a target can comprise using a selector placed in the image plane of a receiving optical system to select a portion of an image of a target formed by a target-backscattered light of a first laser beam for phase conjugation so as to define a pre-distorted second laser beam.

According to an example of an embodiment, a method for enhancing laser beam focusing upon a target can comprise reflecting with phase conjugation of only selected components of incoming light. This facilitates the definition of a reversed wavefront and a reverse direction of propagation such that a laser beam returned to a target tends to be concentrated upon a desired region of a target.

According to an example of an embodiment, a method for performing target-in-the-loop, real-time laser beam phase aberration compensation through a turbulent atmosphere can comprise distinguishing between phase aberration contributed by atmospheric turbulence-induced phase aberration and target-induced phase aberration caused by target surface roughness. A target-scattered laser beam can be detected and characterized so as to facilitate pre-distortion of the outgoing laser beam.

Distinguishing between phase aberration contributions from atmospheric turbulence-induced phase aberration and target-induced phase aberration can comprise performing phase conjugation upon light scattered from a selected spot on the target. The light can be selected from the desired spot of on an image of the target at an image plane.

The method can comprise pre-distorting a laser beam that is directed toward the target. Pre-distorting the laser beam can effect compensation of aberrations in its wavefront caused by two factors, atmospheric perturbations and target surface roughness. Pre-distorting the laser beam can be performed using an optical phase conjugate mirror.

According to an example of an embodiment, a method for enhancing laser beam focusing upon a target can comprise directing a first laser beam through a turbulent atmosphere toward a target so as to illuminate a comparatively large area upon the target, receiving light from the first laser beam that was scattered from the target, focusing the light in an image plane so as to form a blurred image, and selecting a spot on the blurred image with a selector. The selected spot can correspond to a comparatively small area upon the target.

The selected light can be directed to an optical phase conjugate mirror. A second laser beam can be directed from the optical phase conjugate mirror to the target. The second laser beam can at least partially defining a pre-distorted laser beam which, when acted upon by the atmosphere, defines a spot having enhanced focus upon the target.

The selector can comprise a diaphragm having an aperture formed therein such that light passing through the aperture defines the selected spot. The diaphragm can be moveable so as to position the aperture at a desired location within the image plane.

A laser cavity can be defined using an optical phase conjugate mirror as one reflector and using the target as another reflector. Light reflected from a selected region of the target can be selectively allowed to resonate within the laser cavity. Light from non-selected regions of the target can be blocked at an image plane of the target.

According to an example of an embodiment, a system for performing real-time laser beam aberration compensation through a turbulent atmosphere can comprise a laser source, optics for directing light from the laser source upon a target and for forming an image of light scattered from the target, a selector for selecting a specific spot in an image plane, and an optical phase conjugate mirror receiving light from the selected spot in the image plane. The optical phase conjugate mirror can use the light from the selected spot in the image for pre-distorting light that is transmitted back to the target.

The optical phase conjugate mirror can at least partially define the laser source. The optical phase conjugate mirror can be pumped so as to at least partially define the laser source. The laser source can be at least partially defined by a laser cavity that uses the optical phase conjugate mirror as one reflector and that uses the target as another reflector. Light reflected from a selected region of the target can resonate within the laser cavity.

The phase conjugate mirror can be pumped by another laser or other desired method for amplification of the conjugated beam

The laser cavity can contain a gain medium to provide amplification of an intra-cavity beam. The gain medium can be pumped by another laser or by any other desired method.

According to an example of an embodiment, a method for directing a laser beam at a selected location on a target can comprise illuminating a target with a laser beam, forming an image of the target with light scattered by the target, selecting a location on the image, performing phase conjugation on light from the selected location, and directing phase conjugated light to the target.

The phase conjugated light is directed to the location on the target that was selected in the image of the target. Performing phase conjugation both causes the light to be directed to the selected location on the target and enhances focus of light on the target.

The light can be amplified before it is directed back to the target. For example, light from the selected location on the image can be amplified by a laser medium before it is directed back to the target. In this manner, a more intense laser beam can be focused upon a desired location within the target.

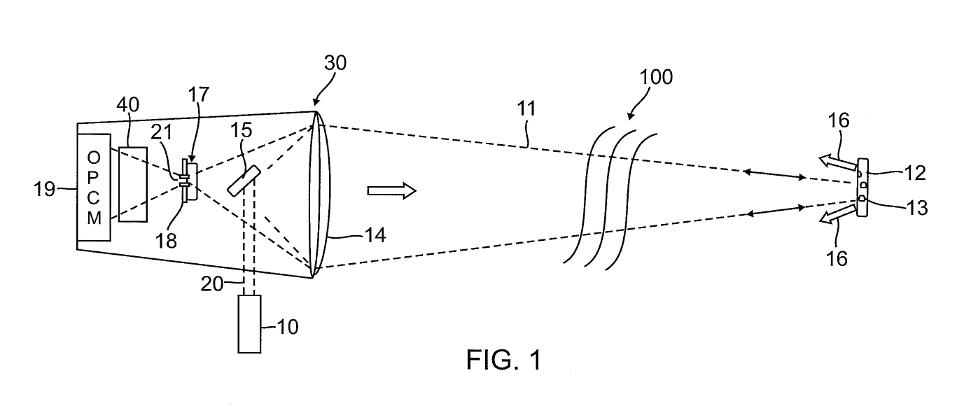

Referring now to FIG. 1, an example of an embodiment of a target-in-the-loop optical phase conjugation laser system 30 is shown. A laser source 10 provides a laser beam 20 to a beam splitter or mirror 15. Mirror 20 can be a curved mirror that expands the laser beam 20 and cooperates with objective lens 14 to form laser beam 11.

The laser source can be an external (with respect to the optical phase conjugation system 30) laser source. The laser source can be an internal laser source that is an integral part of the optical phase conjugation system 30. For example, a laser medium 40 can be disposed within the optical phase conjugation system 30. Such a laser medium 40 can be pumped with light from an external laser source, such as laser 10, or can be pumped by any other desired method.

Laser beam 11 is directed toward a target 12 through a turbulent atmosphere 100. The laser beam 11 illuminates a large area 13 on the target 12. It can be desirable to deliver energy to the target 12 with as much density as possible. This requires good focusing of the laser beam. However, atmospheric turbulence distorts the laser beam and thus inhibits the desired focus.

Laser light is scattered by the target 12. Since the illuminated target has an optically rough surface this adds complexity to the spatial-angular structure of the laser beam 11 scattered by this surface and returning to the laser system 30. This complexity makes it difficult or impossible for contemporary compensation systems to determine contributions to laser beam aberration caused by the target and those caused by atmospheric turbulence.

A receiving objective lens 14 (which can be the same as or different from the lens objective that focuses laser beam 11, e.g., the transmitting objective lens) picks up scattered light 16 from the target 12 and forms an image in the image plane 17. The image will typically be blurred due to the distortion effects caused by atmospheric turbulence.

In the image plane 17 a specific spot can be chosen by placing a selector 18 at a precise position within the image plane 17. The selector 18 can comprise a diaphragm that has an aperture formed therein. The aperture can be aligned within the image plane such that only light from the desired portion of the image is transmitted therethrough. Alternatively, the selector 18 can comprise a spatial light modulator (SLM) wherein one or more pixels transmit or reflect light to choose the desire spot. As a further alternative, the selector 18 can comprise a digital micromirror device (DMD) wherein one or multiplicity of mirrors can reflect light to choose the desire spot.

In this manner, scattered light from only a selected portion of the target 12 is selected. Thus, scattered light from only a desired particular area of the target 12 can be isolated from other light scattered by the target 12 and can be selected. For example, the target illuminating light that backscatters to the receiving lens 14 can form a bright spot at the portion of the image of the target 12 in the image plane. This brighter spot of the image can be selected.

Other criteria for selection can be used. For example, a more useful or vulnerable portion of the target 12 can be selected. In this matter, light from a desired portion of the target can be selected for further processing, e.g., phase conjugation.

Selection of the specific spot of the target 12 can be controlled by an automated process. This automated process can select a spot based upon any desired criteria. For example, the automated process can select a spot based upon the brightness of the illuminated area in the image of the target and/or vulnerability of the area of the interest to be illuminated by laser.

Light that passes through (or reflected off) the aperture of the selector 18 can be directed onto an optical phase conjugation mirror 19. After phase conjugation, light incident upon the optical phase conjugation mirror 19 can travel back to the target 12. As those skilled in the art will appreciate, light reflected by an optical phase conjugation mirror can compensate for or reverse distortion effects of a media within which light travels to reach the optical phase conjugation mirror. An optical phase conjugation mirror causes each ray to be reflected back in the direction it came from. This reflected conjugate wave therefore propagates backwards through the distorting medium in a matter that un-does the distortion caused by the media.

Such compensation of the atmospheric target path effects enables laser energy to be better focused upon the selected target area 13. The degree of concentration of the laser beam depends on the amount of turbulence, as well as upon the ability to compensate for such turbulence. Generally, a substantial increase in laser energy and power density on the target can be achieved by using a small number of iterative cycles. Each iterative cycle can be a round trip of the laser beam between the optical phase conjugation system 30 the target 12. Indeed, the optical phase conjugation mirror 19 and the target 12 can cooperate with a laser medium 40 to define a laser cavity that both provides the laser energy to disrupt or destroy the target 12 and that compensates for atmospheric turbulence.

Two primary effects can be addressed in order to form a well focused hot-spot on the resolved target. One effect is the distortion of the incident laser beam caused by atmospheric turbulence. The other effect is distortion of the laser beam scattered or reflected from the target (which can be used in a feedback loop to change the incident beam) caused by diffuse scattering from the target.

Contemporary methods for atmospheric turbulence compensation are based on the reciprocity of the propagation equation in a steady state inhomogeneous lossless medium. It is well known that inversion of the propagation direction of a laser beam, and the phase conjugation of its complex amplitude, produces a backward propagating wave that is a complete copy of the incoming one. This technique has been proven in various optical phase conjugation schemes.

Thus, the optical phase conjugation technique enables effective compensation of a turbulent atmosphere and complete reconstruction of the field from the source. In this case, such a result implies the prospect of reconstruction of the field distribution in the target plane. This can certainly be applied as a solution for a non-resolved target. However, in the general case of a resolved target, compensation of atmospheric turbulence solely is insufficient for high-density hot-spot formation on the surface of this target.

Indeed, even if complete compensation of atmospheric effects were possible, since the initial spatial distribution of the laser beam on the non-cooperative target (the beacon) is also influenced by this turbulence, the compensation of the latter can be made only to the extent that accounts for the characteristics of the beacon. Thus, conventional optical phase conjugation methods don't allow the achievement of a high-level concentration of the laser beam on the target.

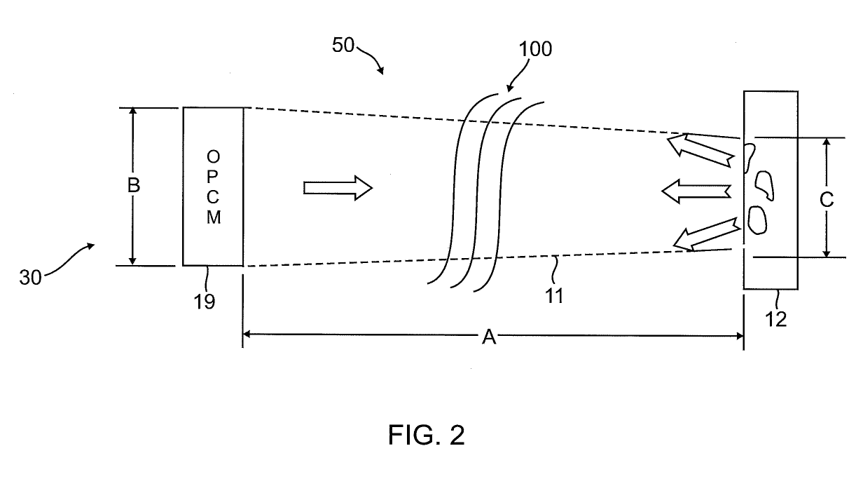

Referring now to FIG. 2, an extended laser cavity 50 can be defined between the optical phase conjugation mirror 19 and the target 12 (such as the optical phase conjugation mirror 19 and target 12 of FIG. 1, for example). This extended laser cavity 50 includes the atmosphere between the optical phase conjugation system 30 and the target 12.

According to one or more embodiments, an optical phase conjugation mirror based target-in-the-loop system defines an extended length laser cavity between the laser system 30 and the target 12. The extended length laser cavity can have a length Dimension A, that extends between the laser system 30 and the target 12. The cavity apertures are defined by the diameter (Dimension B) of the optical phase conjugation mirror 17 and by the size (Dimension C) of the laser spot on the target 12. Clearly, the size (Dimension C) of the laser spot on the target 12 is determined by the divergence of the illuminating laser beam and its changes along its path to the target 12 that are due to atmospheric effects.

In general, a laser cavity comprising the optical phase conjugation mirror 19 can have enhanced quality with respect to other laser cavities with comparable apertures. This enhanced quality can be a result of phase conjugation which compensates the losses related to the intra-cavity optical inhomogeneities and the aperture of the mirrors.

On the other hand, a laser resonator with the optical phase conjugation mirror is less sensitive to diffraction effects on the cavity mirrors of limited aperture and intracavity beam perturbations. As a result, this type of laser cavity achieves oscillation of a high number of transverse modes. Therefore, generating a laser beam of a needed structure using the optical phase conjugation mirror based cavity requires much stronger mode selection capabilities.

Considering an optical phase conjugation mirror capable of compensating the effects associated with a turbulent atmosphere along the laser beam path, one can estimate the minimum spot size on the target projected by this beam. For a laser beam of wavelength λ propagating through the homogeneous atmosphere, the diffraction limited spot size is:

C≅\sqrt{λ·A} (1)

In the case of an extended (resolved) and turbulent atmosphere laser beam propagation through the illuminated area that significantly exceeds the diffraction limited, this results in a Fresnel number of the extended length laser cavity much higher than 1:

$${N}_{F} = \frac{{C}^{2}}{λ \cdot A} >> 1 \qquad ( 2 )$$

A laser resonator with OPCM and a high Fresnel number has an equally high quality value Q for almost all transverse modes, making the cavity non-selective for such modes. The structure of the laser beam for such a cavity is governed by the initial field distribution and the perturbations introduced by the spatially inhomogeneous medium within it.

The optical phase conjugation mirror based extended length laser cavity enables effective control of the spatial structure of the laser beam and subsequently facilitates control of the spot size on the target. It is possible to form controllable size hot-spots on the resolved target. The nature of this effect comes from the distinct features of the optical phase conjugation mirror cavity and its very weak selectivity of transverse modes. An additional important feature of the optical phase conjugation mirror cavity is due to the absence of strict phase relation between its modes, unlike a traditional (mirror-based) cavity.

Even for an initially homogeneous field distribution, the structure of the lasing beam remains multi-mode. At certain conditions the transverse structure of the mode demonstrates periodicity, but for the most part it is random. Therefore, the multi-mode character of the intra-cavity field and the flexible phase relation between the transverse modes enables the formation of a beam of arbitrary structure. However, the weak mode selectivity of the optical phase conjugation mirror cavity requires a selector of spatial modes in order to get the beam with the desired structure. The role of this selector is to suppress all undesirable modes, allowing modes that form the beam with preferred beam structure to survive and lase.

For a typical laser system with optical phase conjugation mirror, shaping of the spatial structure of the lasing beam takes place in the vicinity of the output coupler, which usually is the traditional mirror. For the proposed system, it implies that the beam structure is governed by the selector located on the target. Clearly, this is not the case when a non-cooperative target is of interest.

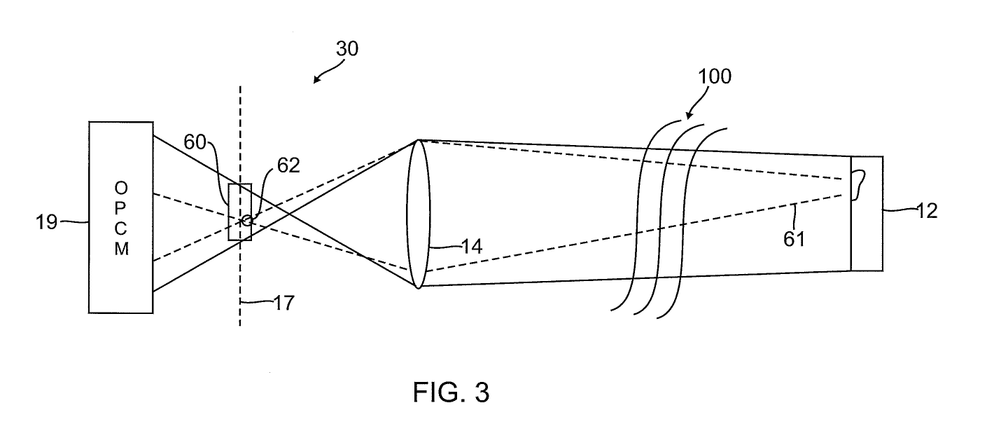

Referring now to FIG. 3, two conjugated hot spots are shown. One conjugate hot spot 61 is on the target 12. The other conjugated hot spot 62 is in the telescope image plane 17.

According to one or more embodiments, beam structure can be defined in the image plane, which is conjugated with the target. For this we can use the optical phase conjugation system shown in FIG. 3 for homogeneous atmosphere.

This optical scheme shows that the optical system image plane 17 has an image 60 of the target 12, i.e., each part of the surface of the target 12 is conjugated with a corresponding area on the image 60. FIG. 3 shows that the image of the given area is formed by a well-defined group of rays.

An area in the image plane can be conjugated with an area of interest on the target surface. For example, by using a diaphragm a transmitted portion of laser beam 11 that is incident upon the optical phase conjugation mirror 19 will only be defined by rays that are from the selected area of the target 12. Clearly, after reflection by the optical phase conjugation mirror 19, the laser radiation will concentrate in the conjugate area on the target 12.

It is worthwhile to appreciate that the optical phase conjugation mirror 19 reflects only selected components of the incoming radiation and restores it in a substantially complete form, with reversed wavefront and direction of propagation, in the image plane. As a result, the returned laser beam will be concentrated around a certain region of the target and can be directed to the preferred location on the target by changing the spatial position of the selector in the image plane.

Assessment of the laser beam focusing efficiency on an extended target can be made by taking into account atmospheric turbulence. For non-turbulent (homogeneous) atmospheric conditions, as shown in FIG. 3, the predominant source of wavefront perturbations come from aberrations caused by optical elements of the system and the limited size of the receiving aperture. The latter sets the diffraction limit in resolution and is not affected by the aberrations of individual optical elements of the system since they are compensated by the optical phase conjugation system 30.

Occurrence of atmospheric turbulence substantially changes the situation as optical inhomogeneity on the path between the target 12 and optical phase conjugation system 30 can result in ambiguous information in the image plane, where every image point may correspond to various points on the target. Placing a selector in the image plane serves to confine a larger region on the target, similar to the conditions of a homogeneous atmosphere. Reiteration of this process resembles the effect of transverse mode selection in the laser cavity with optical phase conjugate mirror. As mentioned above, this type of selection of cavity modes does not reduce the quality of the selected mode, because the optical phase conjugation mirror compensates optical inhomogeneity of the medium within the cavity. By moving the selector in the image plane within the image of the target enables to direct the phase conjugated focused hot-spot to the preferred location on the target.

According to at least one embodiment, a hot-spot can be generated on the target by applying the target-in-loop mechanism, wherein the optical phase conjugation system 30 automatically forms an optimal mode with minimum loses. The rate of selection of the mode with optimal structure can depend upon the difference in the level of losses for the selected mode and the modes to be suppressed.

The selection of a preferred mode in the optical phase conjugation mirror cavity generally requires a much stronger selection mechanism compared to that for a traditional mirror-based laser cavity. The selection method proposed here allows for a substantial increase in mode selectivity, and therefore leads to a reduced number of iteration cycles, i.e., the number of the roundtrips along the cavity. The ability to form a hot spot using a reduced number of iteration cycles can be significant considering the transient character of the atmospheric turbulence and the distance between the target and the laser platform. In this connection, it should be noted that for a fast-operating optical phase conjugation mirror the compensation process is generally effective only when the atmospheric conditions remain substantially unchanged for a roundtrip time between the laser system and target.

As used herein, an extended or resolved target can be defined as a target having a substantial surface area that is not flat. Thus, the effects of scattered beam distortion due to surface roughness can be substantial for extended targets. Satellites, missiles, aircraft, ground vehicles, ships, submarines, and buildings are examples of extended targets.

One or more embodiments facilitate compensation for laser beam aberrations caused by atmospheric turbulence and thus facilitate the formation of a more intense laser beam upon a target. The formation of a more intense laser beam upon a target facilitates the use of lasers in such applications as laser target designation, tracking, pointing, active imaging, and directed energy systems.

Embodiments described above illustrate, but do not limit, the invention. It should also be understood that numerous modifications and variations are possible in accordance with the principles of the present invention. Accordingly, the scope of the invention is defined only by the following claims.

1. A method for enhancing laser beam focusing upon a target, the method comprising selecting a portion of an image of a target formed by a first laser beam and using the selected portion for phase conjugation so as to facilitate the definition of a pre-distorted second laser beam.

2. A method for enhancing laser beam focusing upon a target, the method comprising reflecting only selected components of incoming light so as to define a reversed wavefront and a reverse direction of propagation such that a laser beam returned to a target tends to be concentrated upon a desired region of a target.

3. A method for performing target-in-the-loop, real-time laser beam phase aberration compensation through a turbulent atmosphere, the method comprising distinguishing between phase aberration contributions from atmospheric turbulence-induced phase aberration and target-induced phase aberration caused by target surface roughness.

4. The method as recited in claim 3, further comprising detecting and characterizing a target-scattered laser beam.

5. The method as recited in claim 3, wherein distinguishing between phase aberration contributions from atmospheric turbulence-induced phase aberration and target-induced phase aberration comprises performing phase conjugation upon light scattered from a selected a spot on the target.

6. The method as recited in claim 3, wherein distinguishing between phase aberration contributions from atmospheric turbulence-induced phase aberration and target-induced phase aberration comprises performing phase conjugation upon light scattered from a selected a spot on the target, the light being selected from an image of the target at an image plane.

7. The method as recited in claim 3, wherein distinguishing between phase aberration contributions from atmospheric turbulence-induced phase aberration and target-induced phase aberration comprises selecting a spot in an image plane that is representative of a corresponding spot on the target and performing phase conjugation of light scattered from the target at the selected spot.

8. The method as recited in claim 3, further comprising pre-distorting a laser beam that is directed toward the target and wherein pre-distorting the laser beam effects compensation for both atmospheric perturbations and target surface roughness.

9. The method as recited in claim 3, further comprising pre-distorting a laser beam that is directed toward the target and wherein pre-distorting the laser beam is performed using an optical phase conjugate mirror.

10. A method for enhancing laser beam focusing upon a target, the method comprising:
directing a first laser beam through a turbulent atmosphere toward a target so as to illuminate a comparatively large area upon the target;
receiving light from the first laser beam that was scattered from the target and focusing the light in an image plane so as to form a blurred image;
selecting a spot on the blurred image, the spot corresponding to a comparatively small area upon the target;
directing selected light to an optical phase conjugate mirror; and
directing a second laser beam from the optical phase conjugate mirror to the target, the second laser beam at least partially defining a pre-distorted laser beam which, when acted upon by the atmosphere defines a spot having enhanced focus upon the target.

11. The method as recited in claim 10, wherein selecting a spot comprises selecting the spot with a diaphragm having an aperture formed therein such that light passing through the aperture defines the selected spot, the diaphragm being moveable so as to position the aperture at a desired location within the image plane.

12. A method for enhancing laser beam focus upon a target, the method comprising forming a laser cavity using an optical phase conjugate mirror as one reflector and using the target as another reflector wherein light reflected from a selected region of the target is selectively allowed to resonate within the laser cavity.

13. The method as recited in claim 12, wherein light from non-selected regions of the target is blocked at an image plane of the target.

14. A system for performing real-time laser beam aberration compensation through a turbulent atmosphere, the system comprising:
a laser source;
optics for focusing light from the laser source upon a target and for forming an image of light scattered from the target;
a selector for selecting a specific spot in an image plane; and
an optical phase conjugate mirror receiving light from the selected spot in the image plane for pre-distorting light transmitted to the target.

15. The system as recited in claim 14, wherein the optical phase conjugate mirror at least partially defines the laser source.

16. The system as recited in claim 14, wherein the optical phase conjugate mirror is pumped so as to at least partially define the laser source.

17. The system as recited in claim 14, wherein the laser source is at least partially defined by a laser cavity using the optical phase conjugate mirror as one reflector and using the target as another reflector, wherein light reflected from a selected region of the target resonates within the laser cavity.

18. The system as recited in claim 14, wherein the laser source is at least partially defined by a laser cavity using the optical phase conjugate mirror as one reflector and using the target as another reflector, wherein light reflected from a selected region of the target resonates within the laser cavity and wherein the laser cavity is pumped by an external source.

19. The system as recited in claim 14, wherein the laser source is at least partially defined by a laser cavity using the optical phase conjugate mirror as one reflector and using the target as another reflector, wherein light reflected from a selected region of the target resonates within the laser cavity and wherein the laser cavity contains a lasing media.

20. The system as recited in claim 14, wherein the laser source is at least partially defined by a laser cavity using the optical phase conjugate mirror as one reflector and using the target as another reflector, wherein light reflected from a selected region of the target resonates within the laser cavity and wherein the laser cavity is pumped by another laser.

21. The system as recited in claim 14, wherein the selector comprises a diaphragm having an aperture formed therein.

22. A method for directing a laser beam at a selected location on a target, the method comprising:
illuminating a target with a laser beam;
forming an image of the target with light scattered by the target;
selecting a location on the image;
performing phase conjugation on light from the selected location; and
directing phase conjugated light to the target.

23. The method as recited in claim 22, wherein performing phase conjugation enhances focus of light on the target.

24. The method as recited in claim 22, further comprising amplifying light from the selected location.
